(19) United States
(12) Patent Application Publication
(10) Pub. No.: US 2007/0019328 A1
(43) Pub. Date: Jan. 25, 2007

(54) Laminated magnetic recording media with two sublayers in the lower magnetic layer

(76) Inventors: Mohammad Mirzamaani, San Jose, CA (US); Kai Tang, San Jose, CA (US)

Correspondence Address: G. Marlin Knight;Hoyt & Knight, PO Box 1320, Pioneer, CA, 95666, US

(21) Appl. No.: 11/190,158

(22) Filed: Jul. 25, 2005

(51) Int. Cl. G11B 5/66; G11B 5/82

(52) U.S. Cl. 360/135; 428/828.1; 428/829

(57) ABSTRACT

An embodiment of the invention is a laminated magnetic recording medium comprising two magnetic layers that are substantially decoupled. The lower magnetic layer comprises two sublayers. The upper magnetic sublayer is preferably a cobalt alloy having lower chromium and higher boron content than the lower magnetic sublayer. The upper sublayer composition is selected to have higher coercivity (H_{c}), narrower PW₅₀ and higher resolution. The lower sublayer composition is selected for higher SNR, thermal stability and better overwrite. The laminated structure can also be used in an embodiment which has a slave magnetic layer separated from the lower magnetic layer by an AFC spacer.

### FIELD OF THE INVENTION

The invention relates to magnetic thin film media with laminated magnetic layers and more particularly to magnetic properties and selection of materials used for the plurality of thin films in such media.

### BACKGROUND OF THE INVENTION

A typical prior art head and disk from a magnetic disk drive 10 are illustrated in block form in FIG. 1. In operation the magnetic transducer 20 is supported by the suspension 13 as it flies above the disk 16. The magnetic transducer 20, usually called a “head” or “slider,” is composed of elements that perform the task of writing magnetic transitions (the write head 23) and reading the magnetic transitions (the read head 12). The electrical signals to and from the read and write heads 12, 23 travel along conductive paths (leads) 14 which are attached to or embedded in the suspension 13. The magnetic transducer 20 is positioned over points at varying radial distances from the center of the disk 16 to read and write circular tracks (not shown). The disk 16 is attached to a spindle 18 that is driven by a spindle motor 24 to rotate the disk 16. The disk 16 comprises a substrate 26 on which a plurality of thin films 21 are deposited. The thin films 21 include ferromagnetic material in which the write head 23 records the magnetic transitions in which information is encoded.

The conventional disk 16 includes substrate 26 of glass or AlMg with an electroless coating of Ni₃P that has been highly polished. The thin films on the disk typically include a chromium or chromium alloy underlayer and at least one ferromagnetic layer based on various alloys of cobalt. For example, a commonly used magnetic alloy is CoPtCr. Additional elements such as tantalum and boron are often used in the magnetic alloy. A protective overcoat layer is used to improve wearability and corrosion resistance. Various seed layers, multiple underlayers and laminated magnetic films have all been described in the prior art. The laminated magnetic films have included multiple ferromagnetic layers that are separated by nonmagnetic spacer layers and more recently antiferromagnetic coupling has been proposed. It is known that substantially improved SNR can be achieved by the use of a laminated magnetic layer structure in which two magnetic layers are substantially decoupled. The reduced media noise is believed due to the reduced exchange coupling between the magnetic layers. The use of lamination for noise reduction has been extensively studied to find favorable spacer layer materials which include Cr, CrV, Mo and Ru, and spacer thicknesses from a few angstroms upward that result in the best decoupling of the magnetic layers and the lowest media noise.

Published US patent application 2005/0019609 by Kai Tang (Jan. 27, 2005) describes an embodiment of the invention which includes at least two laminated ferromagnetic layers with differing magnetic anisotropy. The independent magnetic layer farther away from the recording head is selected to have a lower magnetic anisotropy to allow magnetic switching of the multiple magnetic layers to occur at approximately the same head write current even though the recording head field is reduced with increased distance from the head. The improved switching yields improved magnetic recording performance. Laminated magnetic media according to the described invention can have a single peak in the normalized DC erase noise vs. head write current plot indicating that the magnetic transitions in the non-slave magnetic layers are written at the same head write current. As a result the magnetic pulse width (PW₅₀) is reduced, overwrite (OW) is improved and media signal-to-noise ratio (S₀NR) is improved.

Published US patent application 2002/0098390 by H. V. Do, et al. (Jul. 25, 2002) describes a laminated medium for horizontal magnetic recording that includes an antiferromagnetically (AF)-coupled magnetic layer structure and a conventional single magnetic layer. The AF-coupled magnetic layer structure has a net remanent magnetization-thickness product (Mᵣt) which is the difference in the Mᵣt values of its two ferromagnetic films. The type of ferromagnetic material and the thickness values of the ferromagnetic films are chosen so that the net moment in zero applied field will be low, but nonzero. The Mᵣt for the media is given by the sum of the Mᵣt of the upper magnetic layer and the Mᵣt of the AF-coupled layer stack.

The convention for alloy composition used in this application gives the atomic percentage (at. %) of an element as a subscript; for example, CoCr₁₀ is 10 atomic percent Cr with balance being Co and CoPt₁₁Cr₂₀B₇ is 11 atomic percent Pt, 20 atomic percent Cr and 7 atomic percent boron with the balance being Co.

### SUMMARY OF THE INVENTION

An embodiment of the invention is a laminated magnetic recording medium comprising two magnetic layers that are substantially decoupled. The upper and lower magnetic layers are separated by a nonmagnetic spacer. In an embodiment of the invention the lower magnetic layer comprises two sublayers. The upper sublayer (nearest the air-bearing surface) is preferably a cobalt alloy having a lower chromium and a higher boron content than the lower sublayer. The upper sublayer is preferably a cobalt alloy having from 9-17 at. % platinum (Pt), 9-15 at. % chromium (Cr), and 11-17 at. % boron (B). The lower sublayer is preferably a cobalt alloy having higher chromium and lower boron content than the upper sublayer. The lower sublayer is preferably a cobalt alloy having from 9-17 at. % platinum (Pt), 20-28 at. % chromium (Cr), and 4-9 at. % boron (B). The compositions of the upper and lower sublayers are selected to have properties that are different from each other and which would make either one not useful if used alone. The different properties of the sublayers combine to provide improved recording performance according to the invention. The upper sublayer composition is selected to have higher coercivity (H_{c}), narrower PW₅₀ and higher resolution. The lower sublayer composition is selected for higher SNR, thermal stability and better overwrite. The laminated structure can also be used in an embodiment which has a slave magnetic layer separated from the lower magnetic layer by an AFC spacer.

### BRIEF DESCRIPTION OF THE FIGURES

FIG. 1 is a symbolic illustration of the prior art showing the relationships between the head and associated components in a disk drive.

FIG. 2 is an illustration of a prior art layer structure for a magnetic thin film disk with which the magnetic layer stack of the invention can be used.

FIG. 3 is an illustration of a two layer laminated magnetic layer stack for a magnetic thin film disk according to the prior art.

FIG. 4A is an illustration of a laminated magnetic layer stack with the lower magnetic layer comprising first and second sublayers according to the invention.

FIG. 4B is an illustration of a laminated magnetic layer stack with the lower magnetic layer comprising first and second sublayers according to the invention combined with an AFC-coupled magnetic slave layer.

FIG. 5 is a graph of the S₀NR of magnetic films according to the invention versus a prior art example.

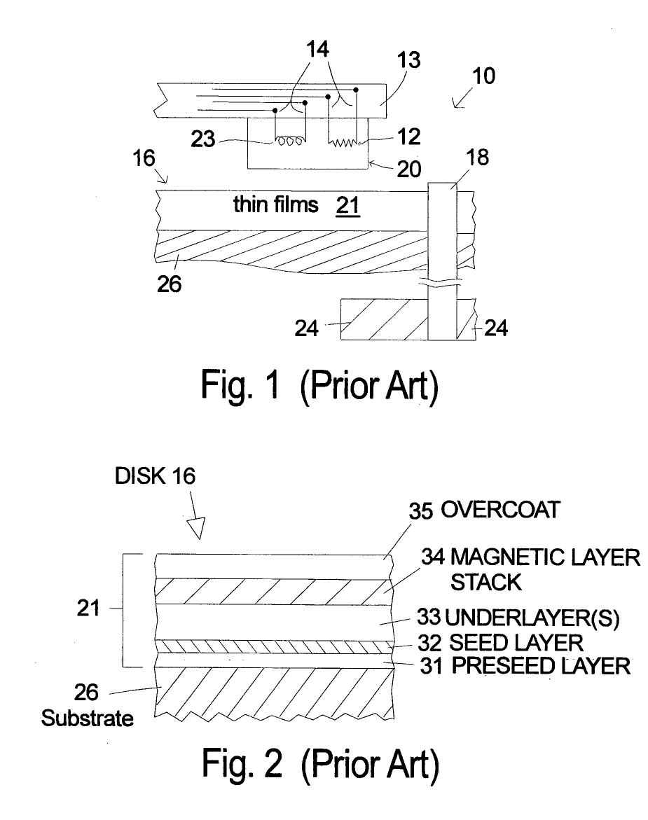

### DETAILED DESCRIPTION OF THE INVENTION AND THE PREFERRED EMBODIMENTS

FIG. 2 illustrates a prior art layer structure 21 of a thin film magnetic disk 16 in which the layer stack according to the invention can be used. The layers under the underlayer(s) 33 may be any of several combinations of seed layers 32 and pre-seed layers 31 as noted in more detail below. Useful pre-seed layers include, but are not limited to, amorphous or nanocrystalline CrTi, CrTiAl or CrTiY. Seed layers are crystalline and are typically used on nonmetallic substrates, but the invention can also be used with metallic substrates such as NiP-coated AlMg. Conventionally NiP-coated AlMg substrates are used with an underlayer structure 33 of Cr, Cr alloy or multiple Cr and Cr alloy layers which are sputter deposited directly onto the NiP. The invention is also not dependent on any particular underlayer being used, but CrTi is used in the preferred embodiment.

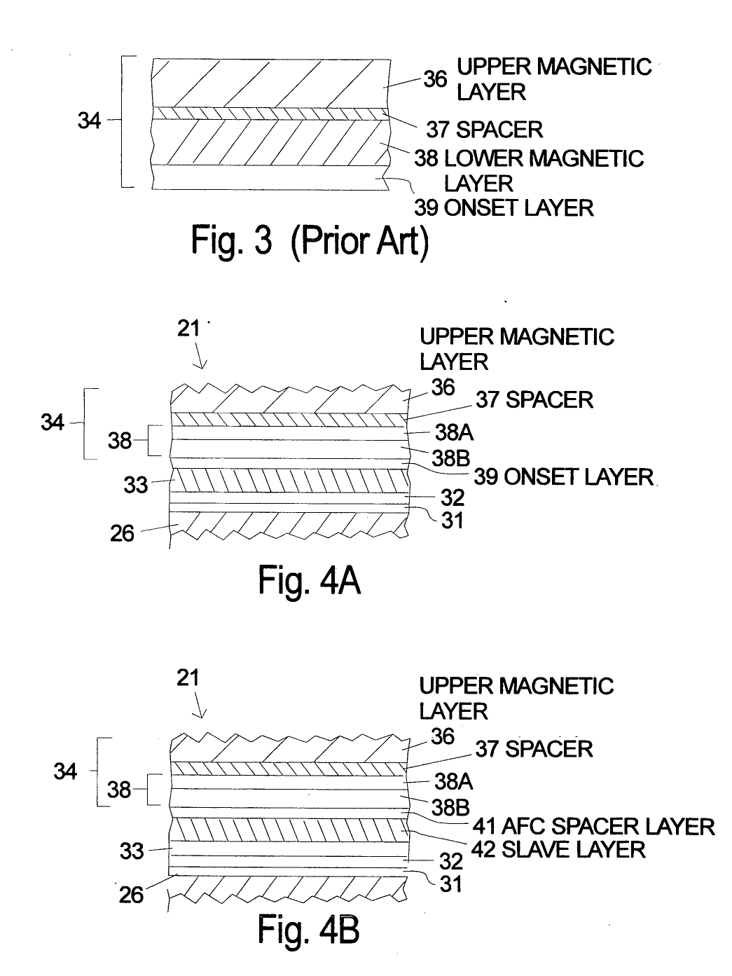

The layer structure shown in FIG. 2 can be used with a variety of magnetic layer stacks 34. For example, a laminated magnetic layer structure can be used as illustrated in FIG. 3. In this structure there is an upper magnetic layer 36, a spacer layer 37, a lower magnetic layer 38 and an onset layer 39. The spacer layer 37 material and thickness are selected according to the prior art to substantially decouple the upper and lower magnetic layers. The preferred method for determining the thickness of the spacer layer is an empirical one in which tests are performed with varying thicknesses to determine the change in S₀NR. For laminated media the S₀NR will change in a gradual manner in a range of thicknesses before dropping sharply at a certain lower thickness. The spacer thickness is selected to be in the range where high S₀NR is achieved. A typical thickness of the spacer layer is about 8 angstroms. The onset layer 39 which is included in the preferred embodiment is described in the prior art. The onset layer material used with the invention is preferably nonmagnetic or weakly ferromagnetic. A preferred material is CoCr having from 18 to 32 at. % Cr.

FIG. 4A illustrates an embodiment of a laminated magnetic layer stack 34 according to the invention. The magnetic layer nearest to the surface of the disk, the upper magnetic layer 36, is selected according to the prior art for laminated media. In a particular embodiment described below CoPt₁₃Cr₁₅B₈ is used for the upper magnetic layer. The preferred spacer layer 37 is ruthenium. The lower magnetic layer 38 comprises upper and lower sublayers 38A, 38B. In the sample embodiment the seed layer 32 is RuAl₅₀ with a B2 structure and the preseed layer 31 is amorphous or nanocrystalline CrTi₅₀. Other onset layers, underlayers, seed layers and preseed layers can be used as taught in the prior art.

The upper magnetic sublayer 38A is preferably a cobalt alloy having relatively lower chromium and higher boron content in relation to the lower sublayer. The upper magnetic sublayer is preferably a cobalt alloy having from 9-17 at. % platinum (Pt), 9-15 at. % chromium (Cr), and 11-17 at. % boron (B). Optionally from 1 to 4 at. % of copper can be added to upper sublayer to possibly improve the SNR. The additional copper, if used, will reduce the cobalt content. The preferred thickness of the upper sublayer 38A is from 40-100 angstroms.

The lower magnetic sublayer 38B is preferably a cobalt alloy having higher chromium and lower boron content than the upper magnetic sublayer. The lower sublayer is preferably a cobalt alloy having from 9-17 at. % platinum (Pt), 20-28 at. % chromium (Cr), and 4-9 at. % boron (B). Optionally from 1 to 2 at. % of tantalum can be added to the lower sublayer to possibly improve segregation of the grains. The additional tantalum, if used, will reduce the cobalt content. The preferred thickness of the lower sublayer 38B is from 60-110 angstroms. Preferably the ratio of the thickness of the upper sublayer divided by the thickness of the lower sublayer should be from 0.35 to 2.5.

The compositions of the upper and lower sublayers are selected to have properties that are different from each other and which would make either one not useful if used alone. The different properties of the sublayers combine to provide improved recording performance according to the invention. The upper sublayer composition is selected to have higher coercivity (H_{c}), narrower PW₅₀ and higher resolution. The lower sublayer composition is selected for higher SNR, thermal stability and better overwrite.

A sample embodiment of the invention was prepared with the following structure:

| | |
|---|---|
| CoPt₁₃Cr₁₅B₈ | upper magnetic layer 36; |
| Ru | spacer 37; |
| CoPt₁₃Cr₁₁B₁₅ | upper magnetic sublayer 38A; |
| CoPt₁₃Cr₂₅B₆ | lower magnetic sublayer 38B; |
| CoCr₂₂ | onset layer 39; |
| CrTi₂₀ | underlayer 33; |
| RuAl₅₀ | seed layer 32; and |
| CrTi₅₀ | preseed layer 31. |

A sample media according to the prior art using a laminated magnetic structure and an AFC coupled slave layer was used for comparison with the embodiment of the invention. The prior art sample had the following structure:

| | |
|---|---|
| CoPt₁₃Cr₁₅B₈ | upper magnetic layer; |
| Ru | spacer; |
| CoPt₁₃Cr₂₀B₅Ta₁ | lower magnetic layer; |
| Ru | AFC spacer; |
| CoCr₁₀ | AFC magnetic slave layer; |
| CrTi₂₀ | underlayer; |
| RuAl₅₀ | seed layer; and |
| CrTi₅₀ | preseed layer. |

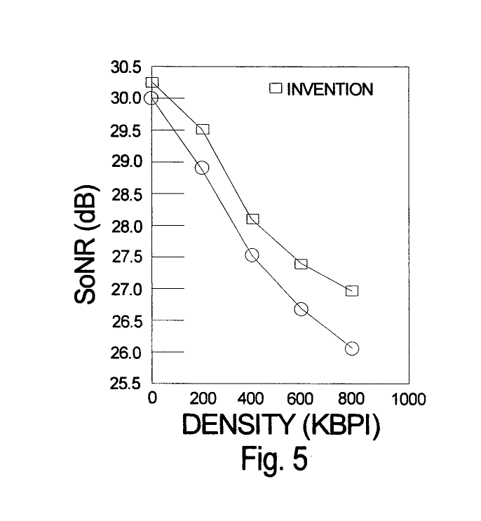

The S₀NR for the samples described above were measured at different bit densities and the results as shown in FIG. 5. The media according to the invention had consistently higher S₀NR from 0 to 800 kilobits per inch (kbpi). The overwrite was also improved in the media according to the invention by over 2 dB. The sector byte error rate was also improved from approximately −5.1 to −5.6 order.

The sublayers as described above can also be used with an antiferromagnetically-coupled (AFC) slave layer. An embodiment of this alternative is shown in FIG. 4B. The compositions and principles as described above for the layers apply in this embodiment as well. The AFC-spacer layer 41 is preferably Ru. The thickness is determined according to the prior art principles and can be expected to be about 6 angstroms. The slave layer 42 is a magnetic material which can be selected according to the prior art. An example is CoCr₁₀ as was used in the comparison media described above. The underlayers, seed layers and preseed layers can be selected according to the prior art.

The thin film structures described above can be formed using standard sputtering techniques. The films are sequentially sputter deposited with each film being deposited on the previous film. The upper and lower sublayers 38A, 38B in the composition ranges given are deposited using negative substrate bias from approximately −100 to −400 volts. The use of bias for these particular composition ranges improves the crystallographic structure and grain segregation.

The atomic percentage compositions given above are given without regard for the small amounts of contamination that invariably exist in sputtered thin films as is well known to those skilled in the art.

The invention has been described with respect to particular embodiments, but other uses and applications for the ferromagnetic structure according to the invention will be apparent to those skilled in the art.

1. A thin film magnetic recording medium comprising:
an upper magnetic layer nearest to a surface of the thin film magnetic recording medium;
a nonmagnetic spacer layer under the upper magnetic layer;
a lower magnetic layer, under the nonmagnetic spacer layer, which is substantially decoupled from the upper magnetic layer, the lower magnetic layer having upper and lower sublayers, the upper sublayer being closer to the surface of the thin film magnetic recording medium than the lower sublayer, and the upper sublayer having a different composition than the lower sublayer.

2. The thin film magnetic recording medium of claim 1 wherein the upper and lower sublayers being an alloy of cobalt, platinum, chromium, and boron with the upper sublayer having a lower atomic percentage of chromium than the lower sublayer and the upper sublayer having a higher atomic percentage of boron than the lower sublayer.

3. The thin film magnetic recording medium of claim 2 wherein the upper sublayer has from 9 to 17 atomic percentage of platinum, 9 to 15 atomic percentage of chromium, and 11 to 17 atomic percentage of boron.

4. The thin film magnetic recording medium of claim 3 wherein the upper sublayer has from 1 to 4 atomic percentage of copper.

5. The thin film magnetic recording medium of claim 2 wherein the lower sublayer has from 9 to 17 atomic percentage of platinum, 20 to 28 atomic percentage of chromium, and 4 to 9 atomic percentage of boron.

6. The thin film magnetic recording medium of claim 5 wherein the lower sublayer has from 1 to 2 atomic percent of tantalum.

7. The thin film magnetic recording medium of claim 2 wherein a ratio of a thickness of the upper sublayer divided by a thickness of the lower sublayer is from 0.35 to 2.5.

8. The thin film magnetic recording medium of claim 2 further comprising an onset layer under the lower sublayer, the onset being an alloy of cobalt which is nonmagnetic or weakly ferromagnetic.

9. The thin film magnetic recording medium of claim 8 further comprising an underlayer of crystalline CrTi under the onset layer.

10. The thin film magnetic recording medium of claim 9 further comprising a seed layer of RuAl under the underlayer.

11. The thin film magnetic recording medium of claim 10 further comprising a preseed layer of amorphous or nanocrystalline CrTi under the seed layer.

12. The thin film magnetic recording medium of claim 2 further comprising an AFC spacer layer under the lower sublayer and a slave magnetic layer under the AFC spacer layer, the slave magnetic layer being antiferromagnetically coupled to the lower sublayer.

13. The thin film magnetic recording medium of claim 1 wherein the lower sublayer has better overwrite than the upper sublayer.

14. The thin film magnetic recording medium of claim 1 wherein the lower sublayer has lower coercivity than the upper sublayer.

15. A magnetic disk drive comprising:
a magnetic head for writing magnetic transitions in a magnetic medium on a disk; and
the disk with a magnetic medium comprising:
an upper magnetic layer nearest to a surface of the disk;
a lower magnetic layer having upper and lower magnetic sublayers, the upper magnetic sublayer being closer to the surface of the disk than the lower magnetic sublayer, the upper and lower magnetic sublayers being an alloy of cobalt, platinum, chromium, and boron, the upper magnetic sublayer having an atomic percentage of boron higher than an atomic percentage of boron in the lower magnetic sublayer, the upper magnetic sublayer having an atomic percentage of chromium lower than an atomic percentage of chromium in the lower magnetic sublayer; and
a nonmagnetic spacer layer separating the upper and lower magnetic layers which substantially decouples the upper magnetic layer from the lower magnetic layer.

16. The magnetic disk drive of claim 15 wherein the upper magnetic sublayer has from 9 to 17 atomic percentage of platinum, 9 to 15 atomic percentage chromium, and 11 to 17 atomic percentage of boron.

17. The magnetic disk drive of claim 16 wherein the upper magnetic sublayer has from 1 to 4 atomic percentage of copper.

18. The magnetic disk drive of claim 15 wherein the lower magnetic sublayer has from 9 to 17 atomic percentage of platinum, 20 to 28 atomic percentage of chromium, and 4 to 9 atomic percentage of boron.

19. The magnetic disk drive of claim 16 wherein the lower magnetic sublayer has from 1 to 2 atomic percentage of tantalum.

20. The magnetic disk drive of claim 15 wherein a ratio of a thickness of the upper magnetic sublayer divided by a thickness of the lower magnetic sublayer is from 0.35 to 2.5.

21. The magnetic disk drive of claim 15 further comprising an onset layer under the lower magnetic sublayer, the onset being an alloy of cobalt which is nonmagnetic or weakly ferromagnetic.

22. The magnetic disk drive of claim 15 further comprising an AFC spacer layer under the lower magnetic sublayer and a slave magnetic layer under the AFC spacer layer, the slave magnetic layer being antiferromagnetically coupled to the lower magnetic sublayer.

23. A method of fabricating a thin film magnetic recording medium comprising the steps of:
depositing a first (lower) magnetic sublayer while applying a negative substrate bias from approximately −100 to −400 volts, the first magnetic sublayer being an alloy of cobalt, platinum, chromium, and boron;
depositing a second (upper) magnetic sublayer on the first magnetic sublayer while applying a negative substrate bias from approximately −100 to −400 volts, the second magnetic sublayer being an alloy of cobalt, platinum, chromium, and boron with an atomic percentage of chromium lower than an atomic percentage of chromium in the first magnetic sublayer and an atomic percentage of boron higher than an atomic percentage of boron in the first magnetic sublayer;
depositing a nonmagnetic spacer layer on the second magnetic sublayer; and
depositing an upper magnetic layer on the nonmagnetic spacer layer with the upper magnetic layer being substantially decoupled from the upper and lower magnetic sublayers.

24. The method of claim 23 wherein the second magnetic sublayer has from 9 to 17 atomic percentage of platinum, 9 to 15 atomic percentage of chromium, and 11 to 17 atomic percentage of boron.

25. The method of claim 24 wherein the second magnetic sublayer has from 1 to 4 atomic percentage of copper.

26. The method of claim 23 wherein the first magnetic sublayer has from 9 to 17 atomic percentage of platinum, 20 to 28 atomic percentage of chromium, and 4 to 9 atomic percentage of boron.

27. The method of claim 23 wherein the lower magnetic sublayer has from 1 to 2 atomic percentage of tantalum.

28. The method of claim 23 wherein a ratio of a thickness of the second sublayer divided by a thickness of the first sublayer is from 0.35 to 2.5.
